(19) United States
(12) Patent Application Publication
(10) Pub. No.: US 2024/0086802 A1
(43) Pub. Date: Mar. 14, 2024

(54) METHODS AND SYSTEMS FOR DETERMINING A CAPITAL EXPENDITURE AND A NON-CAPITAL EXPENDITURE

(71) Applicant: CDK GLOBAL, LLC, Hoffman Estates, IL (US)

(72) Inventors: Vincent Hong, Hoffman Estates, IL (US); Shreekar Inamdar, Hoffman Estates, IL (US); Shravan Ameereddy, Hoffman Estates, IL (US); Rajesh Suram, Hoffman Estates, IL (US)

(21) Appl. No.: 17/930,875

(22) Filed: Sep. 9, 2022

(51) Int. Cl. G06Q 10/06

(52) U.S. Cl. CPC G06Q 10/06313

(57) ABSTRACT

Examples described herein include methods, techniques, and systems for determining the CapEx and the non-CapEx associated with an asset. The asset can be a tangible asset or an intangible asset. To calculate the CapEx of an intangible asset, such as a software product, the methods, techniques, and systems determine the resource investment to build, develop, improve, and/or extend the useful life of the intangible asset. To do so, the methods, techniques, and systems utilize data related to a plurality of professionals associated with the intangible asset. The data related to the plurality of professionals help determine one or more effort levels to build, develop, improve, and/or extend the useful life of the intangible asset. The effort levels, on the other hand, help determine the CapEx of the intangible asset.

### BACKGROUND

A government entity, an institution, an organization, a corporation, a company, a partnership, a person, and/or so forth may invest resources to buy, build, develop, improve, extend the useful life of, or a combination thereof, an asset. The value of the asset is a capital expenditure (CapEx) associated with the asset. Moreover, expenses that do not meet the classification of the CapEx are non-CapEx.

The asset may be a tangible asset or an intangible asset. Examples of tangible assets include a car, land, a building, equipment, a bridge, a road, and/or other assets that a person can touch or see. Examples of intangible (or incorporeal) assets include a brand identity, an intellectual property, a software product, a copyright, a trademark, a patent, and/or any other asset that may not be composed of matter or does not have a material existence. For clarity, the intangible assets exclude tangible assets. In the case of the software product, the software product may include some tangible assets, such as a computer-readable medium. Nevertheless, the asset value of the software product does not rest on the ones and zeros that are stored in the computer-readable medium, but rather on the functions that can be executed using the software product.

Regardless of whether the asset is tangible or intangible, the government entity, the institution, the organization, the corporation, the company, the partnership, and/or the person may need to determine, calculate, and/or track the CapEx of the asset. However, accurately determining the CapEx of building, developing, improving, extending the useful life of, or a combination thereof an intangible asset (e.g., a software product) may be challenging, may include subjective reasoning, and/or may produce significantly inaccurate calculations of the invested resources.

### BRIEF DESCRIPTION OF THE DRAWINGS

FIG. 1 illustrates a block diagram of a company with a plurality of professionals working in one or more business groups to develop, improve, extend the useful life of, and/or maintain one or more software products, in accordance with examples described herein.

FIG. 2 illustrates an environment of a user utilizing a user device to help determine a CapEx, a non-CapEx, or a combination thereof associated with a completed software product, a completed software feature, and/or a completed software sub-feature of the one or more software products, in accordance with examples described herein.

FIG. 3 illustrates a block diagram of a computing device accessing a database with data related to the plurality of professionals that may develop, improve, extend the useful life of, and/or maintain the one or more software products, in accordance with examples described herein.

FIG. 4 illustrates a block diagram of an example method for configuring a third-party project tracking software to determine a CapEx, a non-CapEx, or a combination thereof of the one or more software products, in accordance with examples described herein.

FIG. 5 illustrates a block diagram of another example method for determining a CapEx, a non-CapEx, or a combination thereof of the one or more software products, in accordance with examples described herein.

FIG. 6 illustrates a block diagram of an example method for differentiating the CapEx from the non-CapEx of the one or more software products, in accordance with examples described herein.

### DETAILED DESCRIPTION

Examples described herein include methods, techniques, and systems for calculating the CapEx and the non-CapEx associated with an asset. The asset can be a tangible asset or an intangible asset. Although the described methods, techniques, and systems can be used to calculate the CapEx and the non-CapEx of any asset, the disclosure focuses on calculating the CapEx and the non-CapEx of an intangible asset, such as a software product. To do so, the methods, techniques, and systems determine the resource investment to build, develop, improve, extend the useful life of, and/or maintain the intangible asset. In some embodiments, the resource investment may include a monetary value, time, a count of professionals, a combination thereof, and/or other types of resources. In some embodiments, the methods, techniques, and systems utilize data related to a plurality of professionals associated with the intangible asset. The data related to the plurality of professionals help determine one or more effort levels needed to build, develop, improve, extend the useful life of, and/or maintain the intangible asset. The effort levels, on the other hand, help determine the CapEx and the non-CapEx of the intangible asset.

It is to be appreciated that the methods, techniques, and systems described herein can be implemented with relative ease, reduce (or eliminate) subjective reasoning, and/or reduce inaccuracies in expenditure calculations, such as CapEx and non-CapEx. A software product's accurate CapEx calculations help a company that owns the software product to fully realize any capital gains of the software product. Moreover, the company can determine, calculate, and/or track a CapEx, a non-CapEx, a total software development expenditure, an expenditure-to-budget ratio, a CapEx-to-non-CapEx ratio, or a combination thereof in real-time, in near real-time, or in time intervals.

In one aspect, a computer-implemented method for determining a total resource investment to develop software includes determining, via a first user input, one or more software products, where each of the one or more software products includes a completed software product within a first time period. The computer-implemented method also includes determining, via a second user input, one or more features of each of the one or more software products, where each of the one or more features includes a completed software feature within a second time period. The computer-implemented method also includes determining, via a third user input, one or more sub-features of each of the one or more features, where each of the one or more sub-features includes a completed software sub-feature within a third time period. The computer-implemented method also includes accessing a database with data related to a plurality of professionals developing the one or more software products. Based on the data related to the plurality of professionals, the computer-implemented method includes determining a first effort level associated with each of the one or more sub-features, a second effort level associated with each of the one or more features, and a third effort level associated with each of the one or more software products. After determining the first, the second, and the third effort levels, the computer-implemented method includes calculating a first resource investment of developing software within the third time period, a second resource investment of developing software within the second time period, and a third resource investment of developing software within the first time period. Based on the type of the software product, the method includes determining the CapEx of the software product.

In one aspect, a non-transitory computer-readable storage medium includes instructions that, when executed by at least one processor, configures the at least one processor to perform the above-mentioned method.

In one aspect, a computing apparatus includes a processor and a memory that stores instructions. The instructions, when executed by the processor, configure the apparatus to receive user input, where a user determines at least one completed software product within a first time period, at least one completed software feature within a second time period, and at least one completed software sub-feature within a third time period. Further, the instructions, when executed by the processor, configure the apparatus to access a database with data related to a plurality of professionals developing software. Based on the data related to the plurality of professionals, the apparatus is configured to determine: a first effort level associated with the at least one completed software sub-feature, a second effort level associated with the at least one completed software feature, and a third effort level associated with the at least one completed software product. The determination of the first, the second, and the third effort levels enables the apparatus to calculate: a first resource investment of developing the at least one completed software sub-feature; a second resource investment of developing the at least one completed software feature; and a third resource investment of developing the at least one completed software product. Depending on the type of the completed software product, the completed software feature, and/or the completed software sub-feature, the apparatus can determine a CapEx, a non-CapEx, a total software development expenditure, an expenditure-to-budget ratio, a CapEx-to-non-CapEx ratio, or a combination thereof.

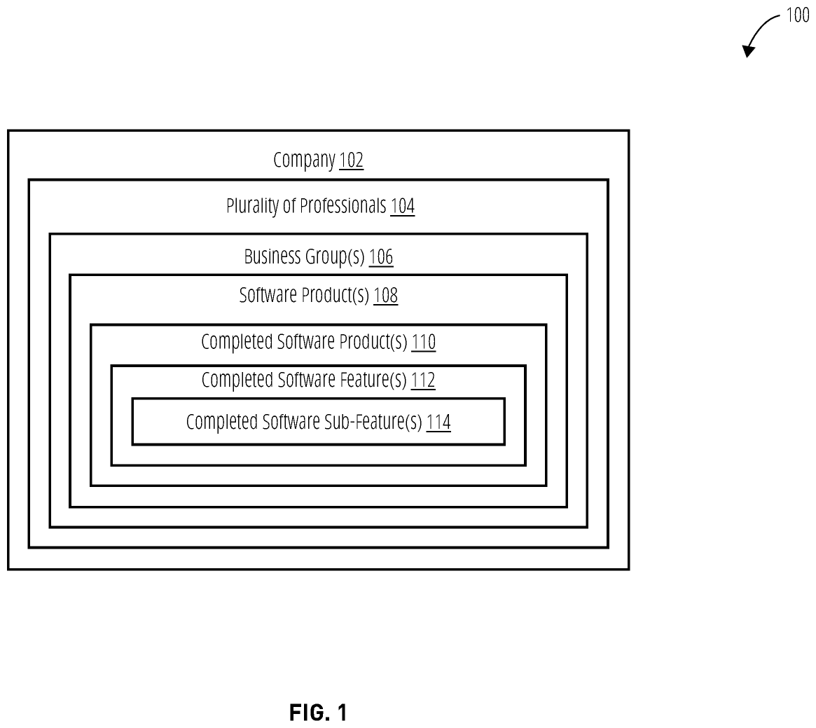

FIG. 1 illustrates a block diagram 100 of a company 102 with a plurality of professionals 104 working in one or more business groups 106 (“business group(s) 106”) to develop, improve, extend the useful life of, and/or maintain one or more software products 108 (“software product(s) 108”), in accordance with examples described herein. The company 102 may be a private company or a public company. Depending on the type and/or the size of the company 102, the business group(s) 106 may be located in different geographic areas (e.g., in different cities, states, countries, continents) or may be co-located (e.g., in one building). Furthermore, depending on the type and/or the size of the company 102, each or some of the business group(s) 106 may be part of different industries or the same industry. For example, the company 102 may be a parent company (e.g., a conglomerate) with multiple business groups (e.g., entities, subsidiaries) that may operate in different industries. As another example, the company 102 may be a multinational company, and each business group may be part of a specific country. As another example, the company 102 may include a first business group that specializes in developing, improving, extending the useful life of, and/or maintaining software products and a second business group that specializes in producing hardware products. As yet another example, the company 102 may be a software development company that may include the business group(s) 106, where each business group specializes in developing, improving, extending the useful life of, and/or maintaining distinct software products.

In some embodiments, one, some, or all of the business group(s) 106 of the company 102 may develop, improve, extend the useful life of, and/or maintain:
one or more software products 108 (“software product(s) 108”) within a first time period;
one or more completed software products 110 (“completed software product(s) 110”) within a second time period;
one or more completed software features 112 (“completed software feature(s) 112”) within a third time period; and/or
one or more completed software sub-features 114 (“completed software sub-feature(s) 114”) within a fourth time period.

In one aspect, the first time period may be an unbound time period, a yet-to-be-determined time period, and/or a determined greater-than-one-year time period (e.g., greater than one fiscal year). In another aspect, the second time period may be a fiscal year; the third time period may be a fiscal quarter; and the fourth time period may be a fiscal month. In yet another aspect, the various time periods may be defined by a chief executive officer (CEO), a chief financial officer (CFO), an owner, a board of directors, a business manager, an accountant, or any other professional working in the company 102. The various time periods (e.g., the fiscal year, the fiscal quarter, and/or the fiscal month) may aid professionals (e.g., plurality of professionals 104) of the company 102 to analyze their budget, software development expenditure, CapEx, non-CapEx, expenditure-to-budget ratio, CapEx-to-non-CapEx ratio, and/or other financial metrics. The company 102 may report these financial metrics in their monthly, quarterly, and/or yearly financial statement(s).

In some embodiments, a determination (or calculation) of the CapEx, the non-CapEx, or a combination thereof of the software product(s) 108, the completed software product(s) 110, the completed software feature(s) 112, and/or the completed software sub-feature(s) 114 may be mandated by a government agency, such as the Internal Revenue Service (IRS), the Securities and Exchange Commission (SEC), a tax commission, and/or other government agencies. In some embodiments, the determination of the CapEx, the non-CapEx, or a combination thereof may be requested by investors of the company 102. In some embodiments, the determination of the CapEx, the non-CapEx, or a combination thereof may be used for budgetary insights that may aid some of the plurality of professionals 104 (e.g., the CEO, the CFO, a business manager, an accountant, or any other professional) to make business decisions.

Generally, the CapEx is the expenditure (e.g., resource investment) that a government entity, an institution, an organization, a corporation, a company (e.g., the company 102), a partnership, a person, and/or so forth may incur (e.g., spend, invest) to buy, build, develop, improve, extend the useful life of, or a combination thereof an asset. Consequently, in some embodiments, the non-CapEx are all other expenses that do not meet the classification of the CapEx. For example, the expenditure (e.g., resource investment) to maintain (or support) the asset is a non-CapEx. For clarity, the total expenditure (e.g., resource investment) to buy, build, develop, improve, extend the useful life of, maintain, or a combination thereof an asset equals the CapEx plus the non-CapEx. In some embodiments, a software product can be considered a long-term asset that may fall under fixed assets, even though the software product may not be physical or tangible in a traditional sense, such as a building or land.

As an analogy to the software product(s), if a company and/or a business group incurs a first expenditure (e.g., resource investment) to build (or buy) a building, the first expenditure may be categorized as a CapEx, and the CapEx may determine the value of the asset. As another example, if a company and/or a business group incurs a second expenditure (e.g., resource investment) to build an addition to the building, the second expenditure may also be categorized as a CapEx. As yet another example, if a company and/or a business group incurs a third expenditure (e.g., resource investment) to replace the roof of the building, the third expenditure of the building may also be categorized as a CapEx, since replacing the roof of the building may extend the useful life of the building (e.g., the asset). If a company and/or a business unit, however, incurs a fourth expenditure (e.g., resource investment) to maintain the lawn of the building, the fourth expenditure may be categorized as a non-CapEx. The total expenditure (e.g., resource investment) associated with the example building is approximately the CapEx plus the non-CapEx.

Similar to the expenditure associated with the example building, the expenditure (e.g., resource investment) associated with buying, developing, improving, extending the useful life of, maintaining (or supporting), or a combination thereof a software product may include a CapEx, a non-CapEx, or a combination thereof, such as the CapEx plus the non-CapEx. However, this disclosure purposely omits determining the expenditure (e.g., monetary cost) of buying a software product, since determining the monetary cost of buying a software product is a straightforward determination. Namely, the monetary cost to buy an asset (e.g., the software product) approximately equals an agreed-upon purchase price of the asset. In this disclosure, in some embodiment, the expenditure (e.g., resource investment) to develop, improve, extend the useful life of, or a combination thereof a software product is CapEx, and the expenditure to maintain (or support) a software product is non-CapEx. Unfortunately, current (e.g., existing, prior art) systems and methods utilized to determine and/or differentiate the CapEx from the non-CapEx of a software product may be considerably difficult to implement, may include subjective reasoning, and/or may produce significantly inaccurate calculations of the invested resources. By contrast, the systems, methods, and techniques described herein can be implemented with relative ease, reduce (or eliminate) subjective reasoning, and/or reduce inaccuracies in calculations of the invested resources.

Continuing with FIG. 1, in some embodiments, the company 102, the plurality of professionals 104, and/or the business group(s) 106 may work over a plurality of years (e.g., a plurality of fiscal years) to develop and/or maintain the software product(s) 108; may work over one fiscal year to develop and/or maintain the completed software product(s) 110; may work over one fiscal quarter to develop and/or maintain the completed software feature(s) 112; and/or may work over one fiscal month to develop and/or maintain the completed software sub-feature(s) 114.

For example, a specific software product of the software product(s) 108 may be a complex operating system (OS) that may take several years to be developed. In such a case, a first portion of the plurality of professionals 104 may work on the development of the OS on a part-time basis; a second portion of the plurality of professionals 104 may work on the development of the OS on a full-time basis; a third portion of the plurality of professionals 104 may maintain existing software solutions that may not be related to the development of the OS; a fourth portion of the plurality of professionals 104 may have previously worked in the company 102, but no longer work in the company 102; a fifth portion of plurality of professionals 104 may be contractor(s) that may work on specific tasks of the development of the OS for a limited time period during the time period it may take to develop the OS; a sixth portion of the plurality of professionals 104 may not develop software; a combination thereof; and/or other scenarios that may not be explicitly described herein. Indeed, determining the CapEx and/or the non-CapEx of the example OS may seem like a daunting task.

However, the OS may include several software portions and/or components, such as a kernel component software, a process execution software component, an interrupt software component, a memory management software component, a multitasking software component, a networking software component, a security software component, a user interface software component, one or more application programming interfaces (APIs), and/or other software components of the OS. In aspects, even though the plurality of professionals 104 may work over a plurality of years to develop, improve, extend the useful life of, and/or maintain the OS (e.g., the software product(s) 108), the plurality of professionals 104 may complete or may commit to complete some software portions and/or components of the OS in shorter time periods, such as within one fiscal year, within one fiscal quarter, within one fiscal month, and/or within another time period.

In some embodiments, the completed software product(s) 110 may be one or more standalone completed software products or one or more portions and/or components of the software product(s) 108. In some embodiments, the completed software feature(s) 112 may be one or more portions and/or components of the completed software product(s) 110. In some embodiments, the completed software sub-feature(s) 114 may be one or more portions and/or components of the completed software feature(s) 112.

Continuing with the example OS, in reference to FIG. 1, the OS may be a software product(s) 108, which may take the company 102, the plurality of professionals 104, and/or the business group(s) 106 a plurality of years to complete and/or deliver to the customer(s). The security software component of the OS may be the completed software product(s) 110, which the company 102, the plurality of professionals 104, and/or the business group(s) 106 have completed or have committed to complete within a fiscal year. Generally, the security software component of the OS strives to provide an integrity, a secrecy, and an availability of the OS, functions of the OS, files of the OS, the peripherals thereof, and/or other aspects of the OS. For example, for the security software component to provide integrity, the objects in the OS should only be accessed by authorized users and/or users that have sufficient rights to make modifications to the OS files and/or resources of the OS. As another example, for the security software component to provide secrecy, the objects of the OS need to be accessible only to a limited number of authorized users. As yet another example, for the security software component to provide availability, the resources of the system must be accessible to all the authorized users. In some embodiments, each of the objectives of the security software component of the OS may be a completed software feature(s) 112, which the company 102, the plurality of professionals 104, and/or the business group(s) 106 have completed or have committed to complete within a fiscal quarter. Each objective of the security software component, however, includes more granular efforts, such as writing the code, testing the effectiveness of the code, integrating the code with other portions of the security software component of the OS, and/or other efforts. In some embodiments, each granular effort associated with each of the objectives of the security software component of the OS may be the completed software sub-feature(s) 114, which the company 102, the plurality of professionals 104, and/or the business group(s) 106 have completed or have committed to complete within a fiscal month.

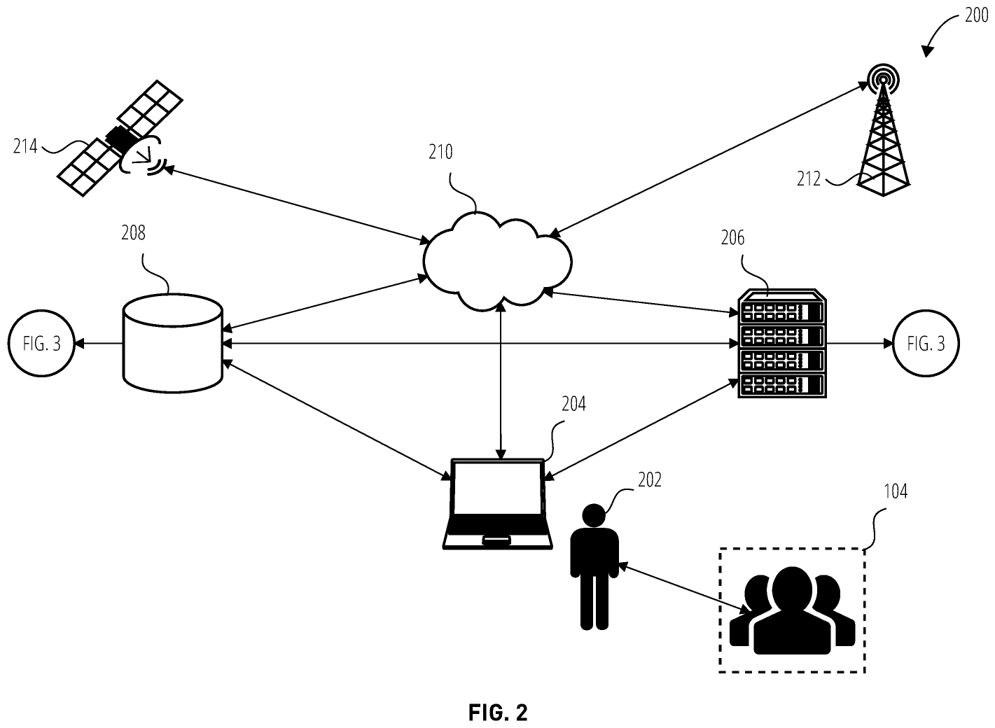

FIG. 2 illustrates an environment 200 of one or more users 202 (“user(s) 202”) utilizing a user device(s) 204 to determine a CapEx, a non-CapEx, or a combination thereof associated with the completed software product(s) 110, the completed software feature(s) 112, and/or the completed software sub-feature(s) 114 of the software product(s) 108, in accordance with examples described herein. FIG. 2 is described in the context of FIG. 1.

In some embodiments, the user(s) 202 may be a business manager, an accountant, a lead software engineer, a software engineer, and/or another professional of the plurality of professionals 104 associated with a software product (e.g., software product(s) 108). In some embodiments, the user(s) 202 may utilize a project tracking software and/or a resource calculation module to determine and/or classify whether a particular task is associated with the completed software product(s) 110, the completed software feature(s) 112, and/or the completed software sub-feature(s) 114 of the software product(s) 108. The project tracking software and/or the resource calculation module may be installed on and/or accessed with the user device(s) 204. In FIG. 2, the user device(s) 204 is illustrated as being a laptop computer. Nevertheless, the user device(s) 204 may be any other user device, such as a desktop computer, a smartphone, a notebook, and/or another example user device that enables the user(s) 202 to determine and/or classify the particular task.

Although the project tracking software and/or the resource calculation module may be installed on and/or accessed with the user device(s) 204, in some embodiments, the project tracking software and/or the resource calculation module may also be installed on a centralized computing device 206 (“computing device 206”). The installation of the project tracking software and/or a resource calculation module on the computing device 206 may enable one, some, or all (e.g., each) of the plurality of professionals 104 to help determine a CapEx, a non-CapEx, or a combination thereof associated with the completed software product(s) 110, the completed software feature(s) 112, and/or the completed software sub-feature(s) 114 of the software product(s) 108.

In some embodiments, the company 102 may utilize one or more databases 208 (“database(s) 208”) to store (e.g., electronically store) data related to the plurality of professionals 104 working at the company 102 (and/or the business group(s) 106). The database(s) 208 may be partly or wholly owned and/or managed by the company 102. Additionally, or alternatively, the database(s) 208 may be partly or wholly managed by a third-party provider, for example, on their respective servers. In some embodiments, the data related to the plurality of professionals 104 may include a name, an employee number (e.g., a badge number), a title, a role, or a combination thereof of each of the plurality of professionals 104. Furthermore, the data related to the plurality of professionals 104 may include a labor cost of each of the plurality of professionals, and the labor cost may include an hourly wage, a salary, a commission, a performance-based labor cost, a bonus pay, a contractor cost, an overhead, time, or a combination thereof.

FIG. 2 illustrates the user device(s) 204, the computing device 206, and the database(s) 208 as being distinct (or separate) entities. Nevertheless, the user device(s) 204, the computing device 206, and the database(s) 208 may be integrated, for example, in one device. Additionally, or alternatively, the user device(s) 204 may be inside an office building of the company 102, while the computing device 206 and/or the database(s) 208 may be on one or more servers that may be outside the office building of the company 102.

In some embodiments, the various devices and/or entities in the environment 200 may communicate with each other directly and/or via a network 210. The network 210 may facilitate communication between the user device(s) 204, the computing device 206, the database(s) 208, a base station(s) 212, a satellite(s) 214, and/or other components (e.g., other user devices) that may not be explicitly illustrated in FIG. 2. Communication(s) in the environment 200 may be performed using various protocols and/or standards. Examples of such protocols and standards include: a 3rd Generation Partnership Project (3GPP) Long-Term Evolution (LTE) standard, such as a 4th Generation (4G) or a 5th Generation (5G) cellular standard; an Institute of Electrical and Electronics Engineers (IEEE) 802.11 standard, such as IEEE 802.11g, ac, ax, ad, aj, or ay (e.g., Wi-Fi 6® or WiGig®); an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); other protocols and/or standards that may be established and/or maintained by various governmental, industry, and/or academic consortiums, organizations, and/or agencies; and so forth. Therefore, the network 114 may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In addition to, or alternatively of, the communications illustrated in FIG. 2, the environment 200 may facilitate other unidirectional, bidirectional, wired, wireless, direct, and/or indirect communications utilizing one or more communication protocols and/or standards. Therefore, FIG. 2 does not necessarily illustrate all of the communication signals utilized in this disclosure.

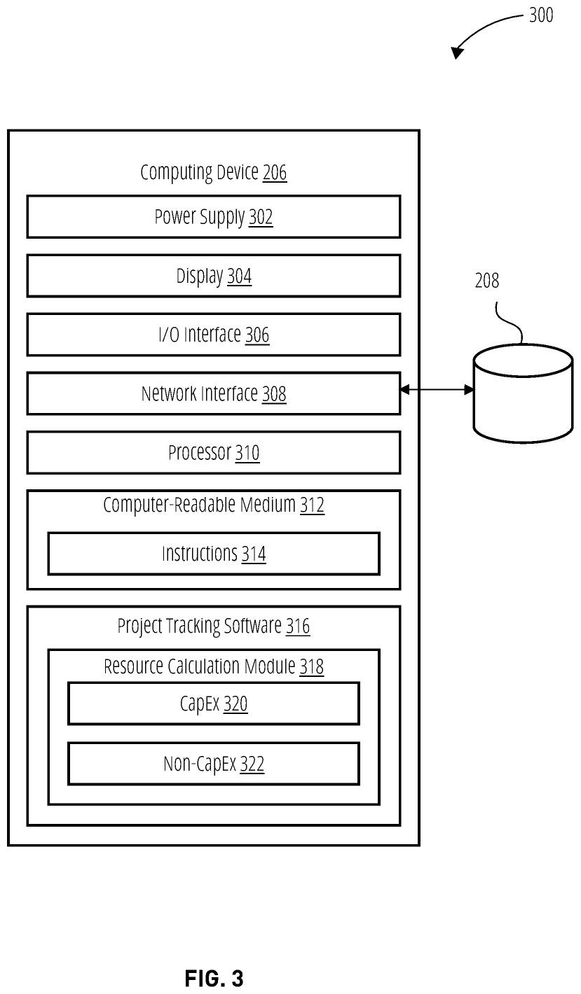

FIG. 3 illustrates a block diagram 300 of the computing device 206 accessing the database(s) 208 with data related to the plurality of professionals 104 that may be developing, improving, extending the useful life of, and/or maintaining the software product(s) 108 or components thereof, in accordance with examples described herein. FIG. 3 is described in the context of FIGS. 1 and 2. In FIG. 3, the example computing device is illustrated as the computing device 206 of FIG. 2. Nevertheless, for the sake of clarity and brevity, the description(s) of FIG. 2 may also be applicable to the user device(s) 204 of FIG. 2 or any other user device and/or computing device that may not be explicitly illustrated in FIGS. 1 and 2.

In some embodiments, the computing device 206 may include a power supply 302, a display 304, an input/output (I/O) interface 306, a network interface 308, at least one processor 310 (“processor 310”), and/or at least one computer-readable medium 312 (“computer-readable medium 312”) that include(s) instructions 314.

In some embodiments, the power supply 302 may provide power to various components within the computing device 206. Further, the power supply 302 may include one or more rechargeable, disposable, or hardwire sources, for example, a battery(ies), a power cord(s), an alternating current (AC) to direct current (DC) inverter (AC-to-DC inverter), a DC-to-DC converter, and/or the like. Additionally, the power supply 302 may include one or more types of connectors or components that provide different types of power (e.g., AC power, DC power) to any device that may be connected to the computing device 206. Additionally, or alternatively, the connector of the power supply 302 may also transmit data to and from any device connected to the computing device 206. For example, the connector of the power supply 302 may facilitate transmission of data to the database(s) 208 of FIG. 2, the user device(s) 204 of the user(s) 202 of FIG. 2, the network 210, and/or any other device that may be capable of receiving and/or transmitting data.

In some embodiments, the display 304 may be optional in the computing device 206 and may only be included in the user device(s) 204 and/or any other device that may communicate with the computing device 206. However, if the computing device 206 (and/or the user device(s) 204) includes and/or utilizes a display 304, the display 304 may display visual information, such as an image(s), a video(s), a graphical user interface (GUI), notifications, and so forth to a user (e.g., user(s) 202). The display 304 may utilize a variety of display technologies, such as a liquid-crystal display (LCD) technology, a light-emitting diode (LED) backlit LCD technology, a thin-film transistor (TFT) LCD technology, an LED display technology, an organic LED (OLED) display technology, an active-matrix OLED (AMOLED) display technology, a super AMOLED display technology, and so forth. Furthermore, the display 304 may be a touchscreen display that may utilize any type of touchscreen technology, such as a resistive touchscreen, a surface capacitive touchscreen, a projected capacitive touchscreen, a surface acoustic wave (SAW) touchscreen, an infrared (IR) touchscreen, and so forth. In such a case, the touchscreen may allow the user device(s) 204 to interact with the computing device 206. For example, using a GUI displayed on the display 304 (e.g., of the user device(s) 204 and/or of the computing device 206), the user(s) 202 may enter information associated with the software product(s) 108, the completed software product(s) 110, the completed software feature(s) 112, the completed software sub-feature(s) 114, and/or the plurality of professionals 104.

In some embodiments, the I/O interface 306 of the computing device 206 may enable the computing device 206 to receive an input(s) from the user(s) 202 of FIG. 2 and provide an output(s) to the user(s) 202, for example, via the user device(s) 204. In some embodiments, the I/O interface 306 may include, be integrated with, and/or may operate in concert and/or in situ with another component of any of the computing device 206, the user device(s) 204, the database(s) 208, the network 210, the base station(s) 212, the satellite(s) 214, and/or so forth.

In some embodiments, the network interface 308 illustrated in FIG. 3 may enable the computing device 206 to receive and/or transmit data directly to any of the network interfaces of any device or component illustrated and/or described in FIG. 2 and/or any other figure in this disclosure. Alternatively, or additionally, the computing device 206 may utilize the network interface 308 to communicate with other devices indirectly by, for example, using the network 210 of FIG. 2. Additionally, or alternatively, the network interface 308 may include and/or utilize an API that may interface and/or translate requests across the network 210 of FIG. 2, and the network interface 308 may support a wired and/or a wireless communication using any of the aforementioned communication protocols and/or standards.

In some embodiments, the processor 310 illustrated in FIG. 3 may be substantially any electronic device that may be capable of processing, receiving, and/or transmitting the instructions 314 that may be included in, permanently or temporarily saved on, and/or accessed by the computer-readable medium 312. In aspects, the processor 310 may be implemented using one or more processors (e.g., a central processing unit (CPU), a graphic processing unit (GPU)), and/or other circuitry, where the other circuitry may include as at least one or more of an application specific integrated circuit (ASIC), a field programmable gate array (FPGA), a microprocessor, a microcomputer, and/or the like. Furthermore, the processor 310 may be configured to execute the instructions 314 in parallel, locally, and/or across the network 210 of FIG. 2, for example, by using cloud and/or server computing resources.

In some embodiments, the computer-readable medium 312 illustrated in FIG. 3 may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth. Moreover, the computer-readable medium 312 does not include transitory propagating signals or carrier waves. Note that the user device(s) 204 may include a computer-readable medium that may be similar to, equivalent to, and/or the same as the computer-readable medium 312 of the computing device 206.

In some embodiments, the instructions 314 may be included in, permanently or temporarily saved on, and/or accessed by the computer-readable medium 312 of FIG. 3. The instructions 314 may include code, pseudo-code, algorithms, models (e.g., machine-learned models), software modules, and/or so forth and are executable by the processor 310. Furthermore, the instructions 314 are suitable to be executed using an operating system (OS, not illustrated) of the computing device 206.

In some embodiments, the computing device 206 of FIGS. 2 and 3 and/or the user device(s) 204 of FIG. 2 can utilize a project tracking software 316. The project tracking software 316 may be developed and maintained by the company 102. Alternatively, the project tracking software 316 may be a third-party project tracking software. The project tracking software 316 may be used at various stages of software development and for various reasons. Nevertheless, this disclosure partly focuses on a resource investment calculation module 318 (“resource calculation module 318”) that may be included in or utilized by the project tracking software 316. The resource calculation module 318 allows the user(s) 202 to determine a CapEx 320, a non-CapEx 322, or a combination thereof associated with the software product(s) 108, the completed software product(s) 110, the completed software feature(s) 112, and/or the completed software sub-feature(s) 114. In some embodiments, the resource calculation module 318, the project tracking software 316, and the instructions 314 may be fully integrated, partly integrated, or fully separate.

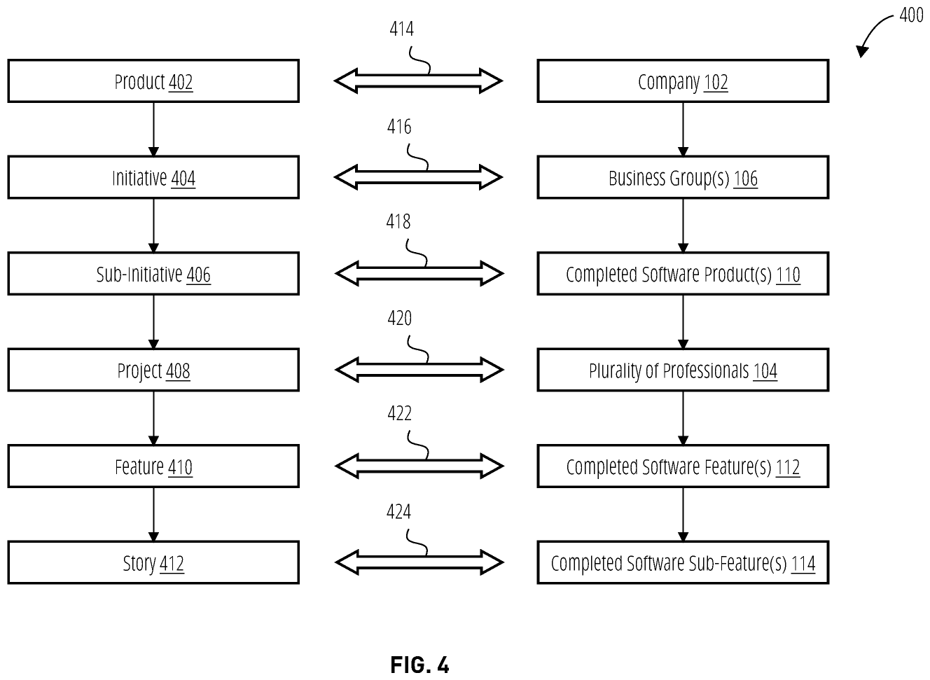

FIG. 4 is a block diagram 400 of an example method for configuring a third-party project-tracking software to determine a CapEx, a non-CapEx, or a combination thereof to develop, improve, extend the useful life of, and/or maintain one or more software products, in accordance with examples described herein. FIG. 4 is described in the context of FIGS. 1 to 3. The steps of the method of FIG. 4 do not necessarily need to be executed in any specific order, or even sequentially, nor need the steps be executed only once, unless otherwise specified. Furthermore, the method can be utilized by using one, more than one, and/or all the steps that are illustrated in FIG. 4. Therefore, the method does not necessarily include a minimum, an optimum, or a maximum number of steps that are needed to implement the systems, methods, and techniques described herein.

As previously discussed, the project tracking software 316 and/or the resource calculation module 318 of FIG. 3 may be developed and maintained by the company 102. Alternatively, the company 102 may utilize a third-party project tracking software and may configure the third-party project tracking software to determine the CapEx and/or the non-CapEx to develop a software product. For example, the user(s) 202 may configure the Jira™ software to determine the CapEx and/or the non-CapEx to develop, improve, extend the useful life of, and/or maintain one or more software products. The Jira™ software, however, may utilize a hierarchical structure (or an organization structure) that may not be purposely designed to replicate the project tracking software 316 and/or the resource calculation module 318 of FIG. 3. As is illustrated in FIG. 4, in one embodiment, the hierarchal structure of the Jira™ software includes a first level, a second level, a third level, a fourth level, a fifth level, and a sixth level. Specifically, the first level is identified as a product 402 level of the Jira™ software; the second level is identified as an initiative 404 level of the Jira™ software; the third level is identified as a sub-initiative 406 level of the Jira™ software; the fourth level is identified as a project 408 level of the Jira™ software; the fifth level is identified as a feature 410 level of the Jira™ software; and the sixth level is identified as a story 412 level of the Jira™ software.

In some aspects, the user(s) 202 may utilize the product 402 level of the Jira™ software to define a company, a line of business, or a plurality of activities that need to be captured at the highest hierarchical level of the Jira™ software. For example, the company may be the company 102. As another example, the line of business may be software development. As yet another example, the plurality of activities may include developing, improving, extending the useful life of, and/or maintaining one or more software products. The time period of the product 402 level of the Jira™ software may be an unbound time period, a yet-to-be-determined time period, and/or a lifetime of the company and/or the line of business. In one embodiment, via a first user input 414, the user(s) 202 may map the company 102 of FIG. 1 to the product 402 level of the Jira™ software.

In some aspects, the user(s) 202 may utilize the initiative 404 level of the Jira™ software to determine an owner of the plurality of activities. The time period of the initiative 404 level of the Jira™ software may be an unbound time period, a yet-to-be-determined time period, a lifetime of the company and/or the line of business, and/or a determined greater-than-one-year time period (e.g., greater than one fiscal year). In one embodiment, via a second user input 416, the user(s) 202 may map the business group(s) 106 of FIG. 1 to the initiative 404 level of the Jira™ software. Although not illustrated as such in FIG. 4, alternatively, the user(s) 202 may map the software product(s) 108 of FIG. 1 to the initiative 404 level of the Jira™ software.

In some aspects, the user(s) 202 may utilize the sub-initiative 406 level of the Jira™ software to determine the CapEx, the non-CapEx, or a combination thereof of a software product that is, or can be, completed within a defined time period, such as within a fiscal year. To configure the Jira™ software to determine the CapEx and/or the non-CapEx, the user(s) 202 recognizes and determines what can be (or become) a completed software product at the end of the defined time period, such as at the end of the fiscal year. For example, at the sub-initiative 406 of the Jira™ software, the user(s) 202 can determine, track, and/or monitor various metrics, such as CapEx, non-CapEx, total software development expenditure, a budget, expenditure-to-budget ratio, a CapEx-to-non-CapEx ratio, and/or other metrics. In one embodiment, via a third user input 418, the user(s) 202 may map the completed software product(s) 110 of FIG. 1 to the sub-initiative 406 level of the Jira™ software.

In some aspects, the user(s) 202 may utilize the project 408 level of the Jira™ software to determine the plurality of professionals that are associated with software development. The time period of the project 408 level of the Jira™ software may be an unbound time period, a yet-to-be-determined time period, a lifetime of the company and/or the line of business, and/or a determined greater-than-one-year time period (e.g., greater than one fiscal year). In one embodiment, via a fourth user input 420, the user(s) 202 may map the plurality of professionals 104 of FIG. 1 to the project 408 level of the Jira™ software. Note that in the hierarchical structure of FIG. 1, the plurality of professionals 104 is immediately below company 102. In the hierarchical structure of FIG. 4, however, the plurality of professionals 104 is immediately below the business group(s) 106. Therefore, the user(s) 202 configures the Jira™ software in such a configuration that enables the user(s) 202 to determine the CapEx and/or the non-CapEx to develop software.

In some aspects, the user(s) 202 may utilize the feature 410 level of the Jira™ software to determine, define, or track completed portions or features of the completed software product(s). In the Jira™ software, the feature 410 level may be dependent on (or is a “child of”) the sub-initiative 406 level. The time period to complete a portion or feature of the completed software product(s) may be increments of the time period of the completed software product(s). For example, the time period at the feature 410 level of Jira™ software may be a fiscal quarter, where the fiscal quarter has a defined start date and end date. In one embodiment, via a fifth user input 422, the user(s) 202 may map the completed software feature(s) 112 of FIG. 1 to the feature 410 level of the Jira™ software.

In some aspects, the user(s) 202 may utilize the story 412 level of the Jira™ software to determine, define, or track software development activities that may be accomplished within a relatively short time interval, such as within a fiscal month. The activities at the story 412 level may be dependent on (or are a “child of”) the feature 410 level of the Jira™ software. For example, in the Jira™ software the activities may have a lifespan of a single sprint. In one embodiment, via a sixth user input 424, the user(s) 202 may map the completed software sub-feature(s) 114 of FIG. 1 to the story 412 level of the Jira™ software. Moreover, the data related with each professional of the plurality of professionals 104 that worked on the activities determined, defined, or tracked at the story 412 level is associated with said activity.

In some embodiments, based on the data related to the plurality of professionals 104, at the story 412 level of the Jira™ software, the user(s) 202 may capture and determine the CapEx and/or the non-CapEx at the smaller granular portions of the completed software product, namely, at the completed software sub-feature(s) 114. Moreover, the user(s) 202 may determine the CapEx, the non-CapEx, or a combination thereof also at the feature 410 level, the sub-initiative 406 level, and/or another level of the Jira™ software.

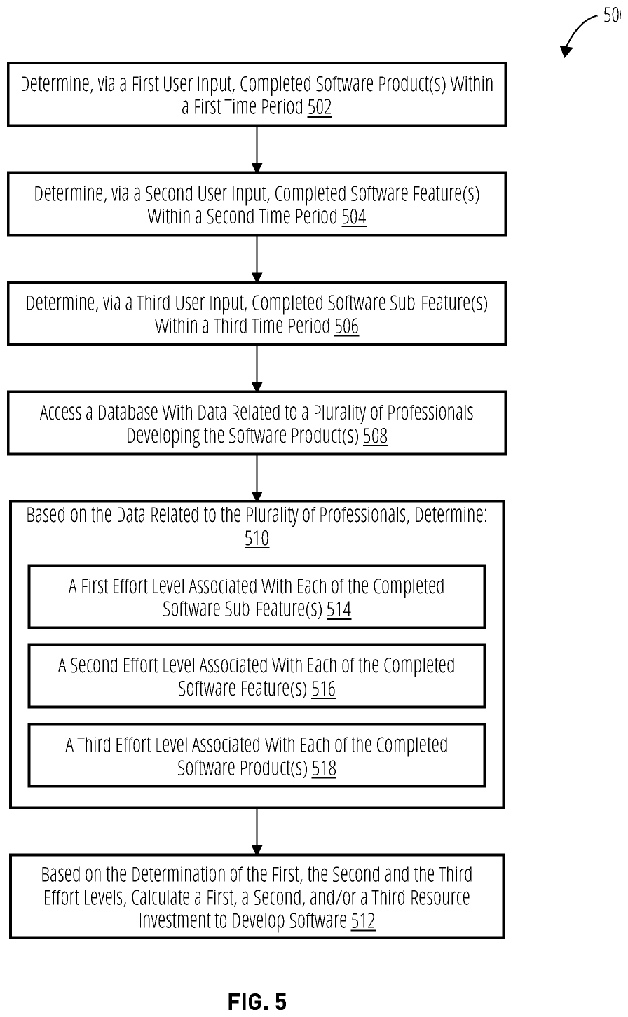

FIG. 5 is a block diagram 500 of an example method for determining a CapEx, a non-CapEx, or a combination thereof of the one or more software products, in accordance with examples described herein. FIG. 5 is described in the context of FIGS. 1 to 4. The steps of the method of FIG. 5 do not necessarily need to be executed in any specific order, or even sequentially, nor need the steps be executed only once, unless otherwise specified. Furthermore, the method can be utilized by using one, more than one, and/or all the steps that are illustrated in FIG. 5. Therefore, the method does not necessarily include a minimum, an optimum, or a maximum number of steps that are needed to implement the systems, methods, and techniques described herein.

At step 502, the method includes determining, via a first user input, one or more software products, where each of the one or more software products is a completed software product within a first time period, such as a fiscal year. Specifically, at step 502, the user(s) 202 may determine, define, or track the completed software product(s) 110 of FIG. 1. In one embodiment, the user(s) 202 may use the user device(s) 204 to utilize the project tracking software 316. Inputs to the project tracking software 316 are data related with the company 102, the plurality of professionals 104, the business group(s) 106, the software product(s) 108, the completed software product(s) 110, the completed software feature(s) 112, and/or the completed software sub-feature(s) 114 of FIG. 1. In one embodiment, the user(s) 202 may map the completed software product(s) 110 of FIG. 1 to the sub-initiative 406 level of the Jira™ software, as is described in regard to FIG. 4.

At step 504, the method includes determining, via a second user input, one or more features of each of the one or more software products, where each of the one or more features is a completed software feature within a second time period, such as a fiscal quarter. Specifically, at step 504, the user(s) 202 may determine, define, or track the completed software feature(s) 112 of FIG. 1. In one embodiment, the user(s) 202 may map the completed software feature(s) 112 of FIG. 1 to the feature 410 level of the Jira™ software, as is described in regard to FIG. 4.

At step 506, the method includes determining, via a third user input, one or more sub-features of each of the one or more features, where each of the one or more sub-features is a completed software sub-feature within a third time period, such as a fiscal month. Specifically, at step 506, the user(s) 202 may determine, define, or track the completed software sub-feature(s) 114 of FIG. 1. In one embodiment, the user(s) 202 may map the completed software feature(s) 112 of FIG. 1 to the story 412 level of the Jira™ software, as is described in regard to FIG. 4.

At step 508, the method includes accessing a database with data related to a plurality of professionals developing the one or more software products, as is described, partly, in regard to FIGS. 2 and 3.

At step 510, the method includes determining a first, a second, and a third level effort of developing software based on the data related to the plurality of professionals 104. In some embodiments, the data related to the plurality of professionals 104 may help determine the effort levels. For example, the senior engineers, computer scientists, and/or software developers may work primarily on new software products, cutting edge software products, and/or more complex software products. As another example, the junior engineers, computer scientists, and/or software developers may work on less complex software products. As yet another example, one, two, or a low count of professionals may not be able to complete the completed software product(s) 110 of FIG. 1. Therefore, in aspects, the step 510 of the method may include additional steps (e.g., sub-routines) to determine the first, the second, and the third level efforts of developing software. Note that step 510 includes three subroutines 514, 516, and 518 before step 512.

At subroutine (or step) 514, the method includes determining a first level effort (e.g., a granular effort) associated with each of the completed software sub-feature(s) 114. At step 516, the method includes a second effort level associated with each of the completed software feature(s) 112. At step 518, the method includes determining a third effort level associated with each of the completed software product(s) 110. In some embodiments, for example, during a planning stage, one or more professionals of the plurality of professionals 104 are assigned to each completed software sub-feature(s) 114. Continuing with the planning stage example, progressing from the identities of the particular professionals assigned to complete each effort level, one or more professionals of the plurality of professionals 104 are assigned to each completed software feature(s) 112, and one or more professionals of the plurality of professionals 104 are assigned to each completed software product(s) 110.

In some embodiments, the user(s) 202 may utilize the project tracking software 316 (or the Jira™ software) to associate the name, the employee number, the title, the role, or the combination thereof of a first count of professionals of the plurality of professionals 104 with the completed software sub-feature(s) 114 within a time period, such as within a fiscal month. Progressively, the user(s) 202 utilizes the project tracking software 316 (or the Jira™ software) to associate the name, the employee number, the title, the role, or the combination thereof of a second count of professionals of the plurality of professionals 104 with the completed software feature(s) 112 within another time period, such as within a fiscal quarter. Likewise, the user(s) 202 utilizes the project tracking software 316 (or the Jira™ software) to associate the name, the employee number, the title, the role, or the combination thereof of a third count of professionals of the plurality of professionals 104 with the completed software product(s) 110 within another time period, such as within a fiscal year.

At step 512, the method includes determining a first resource investment, a second resource investment, and a third resource investment that are associated with the first level effort, the second level effort, and the third level effort, respectively. In some embodiments, the association of the plurality of professionals 104 with the completed software sub-feature(s) 114, the completed software feature(s) 112, and the completed software product(s) 110 enables the resource calculation module 318 of the project tracking software 316 to determine the CapEx, the non-CapEx, or a combination thereof. For example, a labor cost of each of the plurality of professionals 104 may include an hourly wage, a salary, a commission, a performance-based labor cost, a bonus payment, a contractor cost, an overhead, time, or a combination thereof.

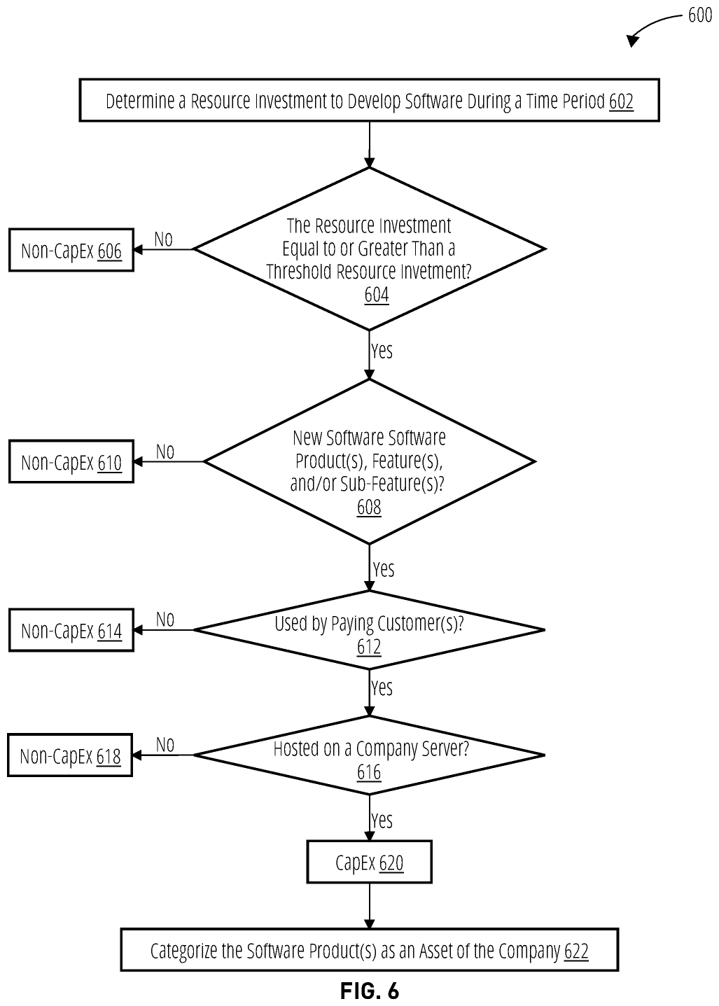

FIG. 6 illustrates a block diagram 600 of an example method for differentiating the CapEx from the non-CapEx of the one or more software products, in accordance with examples described herein. FIG. 6 is described in the context of FIGS. 1 to 5. The steps of the method of FIG. 6 do not necessarily need to be executed in any specific order, or even sequentially, nor need the steps be executed only once, unless otherwise specified. Furthermore, the method can be utilized by using one, more than one, and/or all the steps that are illustrated in FIG. 6. Therefore, the method does not necessarily include a minimum, an optimum, or a maximum number of steps that are needed to implement the systems, methods, and techniques described herein.

FIGS. 1 to 5 describe determining, calculating, and/or tracking the resource investment to develop software. Nevertheless, the user(s) 202 of the company 102 can configure the resource calculation module 318 of the project tracking software 316 to differentiate, calculate, and/or track the CapEx 320 from the non-CapEx 322 to develop software.

At step 602, the method includes determining a total resource investment to develop software (e.g., a particular software product) during a time period, such as in a fiscal month, fiscal quarter, fiscal year, and/or another time period. The user(s) 202 may configure the resource calculation module 318 to flag any software development with a total resource investment that meets or exceeds a threshold resource investment (e.g., $200,000.00, 15 fulltime engineers, two months, etc.). The threshold resource investment may be based on historical data, the CEO, the CFO, a business leader, an accountant, and/or another person working at the company 102. At step 604, the method may determine whether the total resource investment to develop the particular software meets or exceeds the threshold resource investment. If the total resource investment to develop the particular software does not meet or exceed the threshold resource investment, the resource calculation module 318 determines that the resource investment to develop the software is non-CapEx. Consequently, at step 606, the method includes determining, calculating, and/or tracking the total resource investment to develop the particular software to be non-CapEx.

At step 608, the method includes determining, via a user input, whether the particular software product is a new software product, includes a new software feature, includes a new software sub-feature, extends a useful life of a previously developed software product, or a combination thereof. If at step 608 it is determined that a particular software product is not a new software product, does not include a new software feature, does not include a new software sub-feature, does not extend the useful life of a previously developed software product, the method then determines that any effort or resource investment associated with the particular software product is non-CapEx. For example, the effort or the resource investment associated with the particular software product may be fixing a software bug that may have been flagged by one of the plurality of professionals 104 or a paying customer of the particular software product. Consequently, at step 610, the method includes determining, calculating, and/or tracking the total resource investment associated with the particular software product to be non-CapEx.

At step 612, the method includes determining, via a user input, whether the particular software product is used by one or more paying customers. If the particular software product is not used by a paying customer of the company 102, then, most likely, the particular software product is used internally by, for example, the plurality of professionals 104. In such a case, the user(s) 202 does not categorize the particular software to be a monetizable asset of the company 102, even though such a software may increase the efficiency and/or effectiveness of the plurality of professionals 104. Consequently, at step 614, the method includes determining, calculating, and/or tracking the total resource investment associated with the particular software product to be non-CapEx.

At step 616, the method includes determining whether the particular software product is hosted on a server of a company 102. In aspects, step 616 of the method may be closely linked to step 612 of the method. For example, all software products used by paying customers may be hosted on the server of the company 102. If at step 616 it is determined that the particular software product is not hosted on the server of the company 102, the method then determines that any effort or resource investment associated with the particular software product is non-CapEx. Consequently, at step 618, the method includes determining, calculating, and/or tracking the resource investment associated with the particular software product to be non-CapEx.

As is illustrated in the block diagram 600 of FIG. 6, at step 620, the method includes determining, calculating, and/or tracking the resource investment associated with the particular software product to be a CapEx, if the particular software product: meets or exceeds a resource investment that is equal to or greater than the threshold resource investment; is a new software product, includes a new software feature, includes a new software sub-feature, and/or extends a useful life of a previously developed software product; is used by paying customers; and is hosted on a server of the company 102. Finally, if the resource investment associated with the particular product is determined, calculated, and/or tracked as CapEx, at step 622, the method includes categorizing the particular product as an asset of the company 102.

The disclosure includes additional example embodiments of the described methods and systems for calculating CapEx, non-CapEx, or other metrics (e.g., financial metrics) associated with an intangible asset.

### Example Embodiments

Example 1. A computer-implemented method for determining a total resource investment to develop software, the computer-implemented method comprising: determining, via a first user input, one or more software products, wherein each of the one or more software products comprises a completed software product within a first time period; determining, via a second user input, one or more features of each of the one or more software products, wherein each of the one or more features comprises a completed software feature within a second time period; determining, via a third user input, one or more sub-features of each of the one or more features, wherein each of the one or more sub-features comprises a completed software sub-feature within a third time period; accessing a database with data related to a plurality of professionals developing the one or more software products; based on the data related to the plurality of professionals, determining: a first effort level associated with each of the one or more sub-features; a second effort level associated with each of the one or more features; and a third effort level associated with each of the one or more software products; and based on the determination of the first, the second, and the third effort levels, determining: a first resource investment to develop software within the third time period; a second resource investment to develop software within the second time period; and a third resource investment to develop software within the first time period.

Example 2. A non-transitory computer-readable storage medium including instructions that, when executed by at least one processor, configure the at least one processor to perform the method of Example 1.

Example 3. The computer-implemented method of Example 1, wherein the first time period comprises a fiscal year, the second time period comprises a fiscal quarter, and the third time period comprises a fiscal month.

Example 4. The computer-implemented method of Example 1, wherein the second time period is equal to or shorter than the first time period, and the third time period is equal to or shorter than the second time period.

Example 5. The computer-implemented method of Example 1, wherein each of the total resource investment, the first resource investment, the second resource investment, and the third resource investment to develop software comprises a CapEx, a non-CapEx, or a combination thereof.

Example 6. The computer-implemented method of Example 5 further comprises: determining the third resource investment to develop software is equal to or greater than a predefined threshold resource investment; determining, via the first, second, and third user inputs, the one or more software products are new software products, include one or more new software features, include one or more new software sub-features, extend a useful life of one or more previously developed software products, or a combination thereof; determining, via the first, second, and third user inputs, the one or more software products are used by one or more paying customers; determining the one or more software products is hosted on a server of a company owning the one or more software products; and categorizing the one or more software products as an asset of the company.

Example 7. The computer-implemented method of Example 6, wherein the first, the second, and the third resource investments to develop software are the CapEx of the one or more software products.

Example 8. The computer-implemented method of Example 1, wherein the data related to the plurality of professionals comprises: a name, an employee number, a title, a role, or a combination thereof of each of the plurality of professionals; and a labor cost of each of the plurality of professionals, wherein the labor cost comprises an hourly wage, a salary, a commission, a performance-based labor cost, a bonus pay, a contractor cost, an overhead, time, or a combination thereof.

Example 9. The computer-implemented method of Example 8, wherein determining the first, the second, and the third effort levels further comprise: associating, via a project tracking software, the name, the employee number, the title, the role, or the combination thereof of a first count of professionals of the plurality of professionals with the completed software sub-features in the third time period; associating, via the project tracking software, the name, the employee number, the title, the role, or the combination thereof of a second count of professionals of the plurality of professionals with the completed software feature in the second time period; and associating, via the project tracking software, the name, the employee number, the title, the role, or the combination thereof of a third count of professionals of the plurality of professionals with the completed software product in the first time period.

Example 10. The computer-implemented method of Example 9, wherein: the third count of professionals is equal to or greater than the second count of professionals, and the second count of professionals is equal to or greater than the first count of professionals; and the third count of professionals includes the second count of professionals, and the second count of professionals includes the first count of professionals.

Example 11. The computer-implemented method of Example 9, wherein the project tracking software utilizes a resource calculation module to determine a CapEx, a non-CapEx, or a combination thereof to develop software.

Example 12. A computing apparatus (e.g., computing device 206) comprising: a processor (e.g., processor 310); and a memory (e.g., computer-readable medium 312) storing instructions (e.g., instructions 314, project tracking software 316, resource calculation module 318) that, when executed by the processor, configure the apparatus to: receive user input, wherein a user determines: at least one completed software product within a first time period; at least one completed software feature within a second time period; and at least one completed software sub-feature within a third time period; access a database with data related to a plurality of professionals developing software; based on the data related to the plurality of professionals, determine: a first effort level associated with the at least one completed software sub-feature, a second effort level associated with the at least one completed software feature, and a third effort level associated with the at least one completed software product; and based on the determination of the first, the second, and the third effort levels, determine: a first resource investment to develop the at least one completed software sub-feature; a second resource investment to develop the at least one completed software feature; and a third resource investment to develop the at least one completed software product.

Example 13. The computing apparatus of Example 12, wherein the third resource investment is equal to or greater than the second resource investment, and the second resource investment is equal to or greater than the first resource investment.

Example 14. The computing apparatus of Example 12, wherein the at least one completed software product includes the at least one completed software feature, and the at least one completed software feature includes the at least one completed software sub-feature.

Example 15. The computing apparatus of Example 12, wherein the third level effort comprises a greater effort than the second level effort, and the second level effort comprises a greater effort than the first level effort.

Example 16. The computing apparatus of Example 15, wherein the first level effort comprises a granular effort of developing software.

Example 17. The computing apparatus of Example 14, wherein a first count of the at least one completed software product is equal to or greater than a second count of the at least one completed software feature, and the second count is greater than a third count of the at least one completed software sub-feature.

Example 18. The computing apparatus of Example 12, wherein the instructions, when executed by the processor, further configure the apparatus to determine a CapEx, a non-CapEx, a total software development expenditure, an expenditure-to-budget ratio, a CapEx-to-non-CapEx ratio, or a combination thereof.

Example 19. The computing apparatus of Example 18, wherein the CapEx comprises a monetary asset value of the at least one completed software product, the at least one completed software feature, the at least one completed software sub-feature, or a combination thereof.

Example 20. The computing apparatus of Example 18, wherein the third resource investment comprises a total resource investment to develop software.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention in this regard; no attempt is made to show algorithm details of the invention in more detail than is necessary for the fundamental understanding of the invention, the description taken with the drawings and/or examples making apparent to those skilled in the art how the several forms of the invention may be embodied in practice.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize them.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A computer-implemented method for determining a total resource investment to develop software, the computer-implemented method comprising:
determining, via a first user input, one or more software products, wherein each of the one or more software products comprises a completed software product within a first time period;
determining, via a second user input, one or more features of each of the one or more software products, wherein each of the one or more features comprises a completed software feature within a second time period;
determining, via a third user input, one or more sub-features of each of the one or more features, wherein each of the one or more sub-features comprises a completed software sub-feature within a third time period;
accessing a database with data related to a plurality of professionals developing the one or more software products;
based on the data related to the plurality of professionals, determining:
a first effort level associated with each of the one or more sub-features;
a second effort level associated with each of the one or more features; and
a third effort level associated with each of the one or more software products; and
based on the determination of the first, the second, and the third effort levels, determining:
a first resource investment to develop software within the third time period;
a second resource investment to develop software within the second time period; and
a third resource investment to develop software within the first time period.

2. A non-transitory computer-readable storage medium including instructions that, when executed by at least one processor, configure the at least one processor to perform the method of claim 1.

3. The computer-implemented method of claim 1, wherein the first time period comprises a fiscal year, the second time period comprises a fiscal quarter, and the third time period comprises a fiscal month.

4. The computer-implemented method of claim 1, wherein the second time period is equal to or shorter than the first time period, and the third time period is equal to or shorter than the second time period.

5. The computer-implemented method of claim 1, wherein each of the total resource investment, the first resource investment, the second resource investment, and the third resource investment to develop software comprises a CapEx, a non-CapEx, or a combination thereof.

6. The computer-implemented method of claim 5 further comprises:
determining the third resource investment to develop software is equal to or greater than a predefined threshold resource investment;
determining, via the first, second, and third user inputs, the one or more software products are new software products, include one or more new software features, include one or more new software sub-features, extend a useful life of one or more previously developed software products, or a combination thereof;
determining, via the first, second, and third user inputs, the one or more software products are used by one or more paying customers;
determining the one or more software products are hosted on a server of a company owning the one or more software products; and
categorizing the one or more software products as an asset of the company.

7. The computer-implemented method of claim 6, wherein the first, the second, and the third resource investments to develop software are the CapEx of the one or more software products.

8. The computer-implemented method of claim 1, wherein the data related to the plurality of professionals comprises:
a name, an employee number, a title, a role, or a combination thereof of each of the plurality of professionals; and
a labor cost of each of the plurality of professionals, wherein the labor cost comprises an hourly wage, a salary, a commission, a performance-based labor cost, a bonus pay, a contractor cost, an overhead, time, or a combination thereof.

9. The computer-implemented method of claim 8, wherein determining the first, the second, and the third effort levels further comprises:
associating, via a project tracking software, the name, the employee number, the title, the role, or the combination thereof of a first count of professionals of the plurality of professionals with the completed software sub-features in the third time period;
associating, via the project tracking software, the name, the employee number, the title, the role, or the combination thereof of a second count of professionals of the plurality of professionals with the completed software feature in the second time period; and
associating, via the project tracking software, the name, the employee number, the title, the role, or the combination thereof of a third count of professionals of the plurality of professionals with the completed software product in the first time period.

10. The computer-implemented method of claim 9, wherein:
the third count of professionals is equal to or greater than the second count of professionals, and the second count of professionals is equal to or greater than the first count of professionals; and
the third count of professionals includes the second count of professionals, and the second count of professionals includes the first count of professionals.

11. The computer-implemented method of claim 9, wherein the project tracking software utilizes a resource calculation module to determine a CapEx, a non-CapEx, or a combination thereof to develop software.

12. A computing apparatus comprising:
a processor; and
a memory storing instructions that, when executed by the processor, configure the apparatus to:
receive user input, wherein a user determines:
at least one completed software product within a first time period;
at least one completed software feature within a second time period; and
at least one completed software sub-feature within a third time period;
access a database with data related to a plurality of professionals developing software;
based on the data related to the plurality of professionals, determine: a first effort level associated with the at least one completed software sub-feature, a second effort level associated with the at least one completed software feature, and a third effort level associated with the at least one completed software product; and
based on the determination of the first, the second, and the third effort levels, determine: a first resource investment to develop the at least one completed software sub-feature; a second resource investment to develop the at least one completed software feature; and a third resource investment to develop the at least one completed software product.

13. The computing apparatus of claim 12, wherein the third resource investment is equal to or greater than the second resource investment, and the second resource investment is equal to or greater than the first resource investment.

14. The computing apparatus of claim 12, wherein the at least one completed software product includes the at least one completed software feature, and the at least one completed software feature includes the at least one completed software sub-feature.

15. The computing apparatus of claim 12, wherein the third level effort comprises a greater effort than the second level effort, and the second level effort comprises a greater effort than the first level effort.

16. The computing apparatus of claim 15, wherein the first level effort comprises a granular effort of developing software.

17. The computing apparatus of claim 14, wherein a first count of the at least one completed software product is equal to or greater than a second count of the at least one completed software feature, and the second count is greater than a third count of the at least one completed software sub-feature.

18. The computing apparatus of claim 12, wherein the instructions, when executed by the processor, further configure the apparatus to determine a CapEx, a non-CapEx, a total software development expenditure, an expenditure-to-budget ratio, a CapEx-to-non-CapEx ratio, or a combination thereof.

19. The computing apparatus of claim 18, wherein the CapEx comprises a monetary asset value of the at least one completed software product, the at least one completed software feature, the at least one completed software sub-feature, or a combination thereof.

20. The computing apparatus of claim 18, wherein the third resource investment comprises a total resource investment to develop software.
